(19) United States
(12) Patent Application Publication
(10) Pub. No.: US 2014/0313107 A1
(43) Pub. Date: Oct. 23, 2014

(54) PIXEL AND ORGANIC LIGHT EMITTING DISPLAY DEVICE HAVING THE SAME

(71) Applicant: Samsung Display Co., Ltd., Yongin-City (KR)

(72) Inventor: Jae-Sic Lee, Yongin-City (KR)

(21) Appl. No.: 14/052,485

(22) Filed: Oct. 11, 2013

(30) Foreign Application Priority Data
Apr. 23, 2013 (KR) 10-2013-0044822

(51) Int. Cl. G09G 3/32

(52) U.S. Cl. CPC G09G 3/3258
USPC 345/76

(57) ABSTRACT

There are provided a pixel and an organic light emitting display device having the same which can be repaired. The pixel includes a plurality of lines configured to include a scan line, a data line and a first power line, the plurality of lines arranged in a first or second direction; a pixel circuit coupled to the lines; and an organic light emitting diode coupled between the pixel circuit and a second power source. A first line disposed in the first direction among the lines intersects while overlapping with a second line disposed in the second direction among the lines or one or more electrodes on another layer, and the first line is divided to have a plurality of paths in at least one region in the overlapping region of the first line with the second line or the one or more electrodes.

### CLAIM OF PRIORITY

This application makes reference to, incorporates the same herein, and claims all benefits accruing under 35 U.S.C. §119 from an application earlier filed in the Korean Intellectual Property Office on 23 Apr. 2013 and there duly assigned Serial No. 10-2013-0044822.

### BACKGROUND OF THE INVENTION

1. Field of the Invention

An aspect of the present invention relates to a pixel and an organic light emitting display device having the same.

2. Description of the Related Art

Recently, there have been developed various types of flat panel display devices capable of advantageously reducing the weight and volume of cathode ray tubes. The flat panel display devices include a liquid crystal display device, a field emission display device, a plasma display panel, an organic light emitting display device, and the like.

Among these flat panel display devices, the organic light emitting display device displays images using organic light emitting diodes that emit light through recombination of electrons and holes. The organic light emitting display device has a faster response speed and is driven with lower power consumption.

### SUMMARY OF THE INVENTION

Embodiments of the present invention provide a pixel and an organic light emitting display device having the same which can be repaired.

According to an aspect of the present invention, there is provided a pixel including: a plurality of lines configured to include a scan line, a data line and a first power line, the plurality of lines arranged in a first or second direction; a pixel circuit coupled to the lines; and an organic light emitting diode coupled between the pixel circuit and a second power source. A first line disposed in the first direction among the lines intersects while overlapping with a second line disposed in the second direction among the lines or with one or more electrodes on another layer, and the first line is divided to have a plurality of paths in at least one region in the overlapping region of the first line with the second line or the one or more electrodes.

The first line may be formed so that the divided paths are put together at the front end and rear end of the region divided to have the plurality of paths.

The first and second lines or the first line and one or more electrodes may intersect each other with an insulation layer interposed therebetween.

The width of the first line in the overlapping region may be formed wider than that of the second line.

The first line may be set as the first power line.

One or more paths among the divided paths of the first line may be electrically coupled to the second line or the one or more electrodes at the intersection portion of the first and second lines or the intersection portion of the first line and the one or more electrodes. The path electrically coupled to the second line or the one or more electrodes may be isolated from the other paths of the first line.

According to an aspect of the present invention, there is provided an organic light emitting display device, including: a plurality of lines configured to include scan lines, data lines and first power lines, arranged in a first or second direction; and a plurality of pixels arranged at intersection portions of the scan lines, the data lines and the first power lines. Each pixel includes: a pixel circuit coupled a scan line, a data line and a first power line on a corresponding row or column among the lines; and an organic light emitting diode coupled between the pixel circuit and a second power source. A first line disposed in the first direction among the lines intersects while overlapping with a second line disposed in the second direction among the lines or with one or more electrodes on another layer, and the first line is divided to have a plurality of paths in at least one region in the overlapping region of the first line with the second line or the one or more electrodes.

The first line may be formed to have one or more openings in the overlapping region of the first line with the second line or the one or more electrodes.

The first and second lines or the first line and one or more electrodes may intersect each other with an insulation layer interposed therebetween.

The width of the first line in the overlapping region may be formed wider than that of the second line.

One or more paths among the divided paths of the first lines, provided in one or more pixels among the pixels, may be electrically coupled to the second line or the one or more electrodes at the overlapping region of the path with the second line or the one or more electrodes. The path electrically coupled to the second line or the one or more electrodes may be isolated from the other paths of the first line.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a block diagram illustrating an organic light emitting display device according to an embodiment of the present invention.

FIG. 2 is a circuit diagram illustrating an embodiment of a pixel shown in FIG. 1.

FIG. 3 is a waveform diagram illustrating driving signals supplied to the pixel shown in FIG. 2.

FIG. 4A shows two lines intersecting each other in a pixel, and particularly, is a main part plan view illustrating an example of a first line divided so that at least one region of the first line has a plurality of paths according to the embodiment of the present invention.

FIG. 4B is a sectional view taken along line I-I′ of FIG. 4A.

FIG. 5A is a main part plan view illustrating another embodiment in which the positions of the two lines shown in FIG. 4 are changed.

FIG. 5B is a sectional view taken along line II-II′ of FIG. 5A.

FIGS. 6A and 6B are main part plan views illustrating a repairing method of the pixel and a repairing structure of the pixel according to the embodiment of the present invention.

### DETAILED DESCRIPTION OF THE INVENTION

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

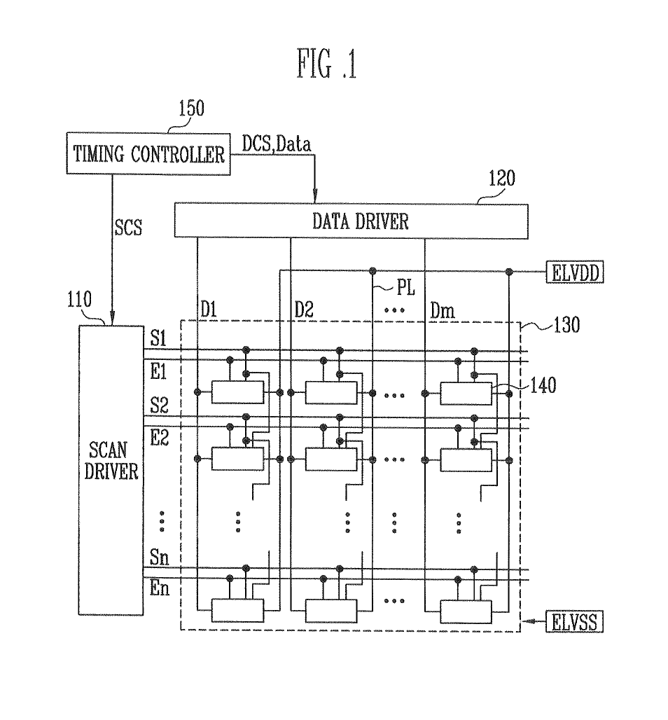

FIG. 1 is a block diagram illustrating an organic light emitting display device according to an embodiment of the present invention.

In reference to FIG. 1, the organic light emitting display device according to this embodiment includes a pixel unit 130 configured to include a plurality of lines having scan lines S1 to Sn, data lines D1 to Dm and first power lines PL, and pixels 140 arranged at intersection portions of the plurality of the lines; a scan driver 110 configured to drive the scan lines S1 to Sn; a data driver 120 configured to drive the data lines D1 to Dm; a timing controller 150 configured to control the scan driver 110 and the data driver 120. The organic light emitting display device may further include control lines such as emission control lines E1 to En according to the internal configuration of the pixels 140. Here, the emission control lines E1 to En may be driven by the scan driver 110, or may be driven by a separate emission control driver (not shown), etc.

The scan lines S1 to Sn, the emission control lines E1 to En, the data lines D1 to Dm and the first power lines PL may be arranged in a first direction, e.g., a lateral direction, or a second direction, e.g., a longitudinal direction, intersecting the first direction.

For example, the scan lines S1 to Sn and the emission control lines E1 to En may be arranged along the lateral direction in order to select pixels for each horizontal lines, and the data lines D1 to Dm may be arranged along the longitudinal direction intersecting the scan lines S1 to Sn in order to supply a data signal each pixel 140 on a horizontal line selected by the scan lines S1 to Sn. The first power lines PL may be arranged in the lateral or longitudinal direction, or may be arranged in the lateral and longitudinal directions so as to be formed in a mesh form, etc.

That is, a plurality of lines configured to supply various kinds of signals and power to each pixel 140 are arranged in the pixel unit 130, and some of the plurality of lines intersect each other.

Each pixel 140 includes a pixel circuit coupled to a scan line S, an emission control line E, a data line D and a first power line PL on a corresponding row or column, and an organic light emitting diode controlled by the pixel circuit. The pixel 140 may be further coupled to a scan line on the previous row, another control line (not shown), etc. according to the structure of the pixel circuit.

The pixels 140 receive a data signal through the data lines D1 to Dm when a scan signal is supplied from the scan lines S1 to Sn, and emit light with a luminance corresponding to the data signal during an emission period controlled by an emission control signal supplied from the emission control lines E1 to En, thereby displaying an image.

Meanwhile, the pixels 140 receive first and second power sources ELVDD and ELVSS supplied to emit light. To this end, for example, the first power source ELVDD may be supplied to the pixels 140 through the first power lines PL1, and the second power source ELVSS may be supplied to the pixels 140 through a second electrode (not shown) entirely formed in the pixel unit 130.

The scan driver 110 receives a scan driving control signal SCS supplied from the timing controller 150, and generates a scan signal corresponding to the scan driving control signal SCS. The scan signal generated in the scan driver 110 is progressively supplied to the pixels 140 through the scan lines S1 to Sn. The scan driver 110 may further generate an emission control signal, corresponding to the scan driving control signal SCS. The emission control signal generated in the scan driver 110 is supplied to the pixels 140 through the emission control lines E1 to En. Here, the width of the emission control signal may be set, for example, identical to or wider than that of the scan signal. For example, the emission control signal supplied to an i-th (i is a natural number) emission control line Ei may be supplied to overlap with the scan signal supplied to an (i−1)-th and i-th scan lines Si−1 and Si.

The data driver 120 receives a data driving control signal DCS and a data Data, supplied from the timing controller 150. The data driver 120 generates a data signal, corresponding to the data driving control signal DCS and the data Data, and supplies the generated data signal to the data lines D1 to Dm so as to be synchronized with the scan signal.

The timing controller 150 generates the scan driving control signal SCS and the data driving control signal DCS, corresponding to synchronization signals supplied from the outside of the organic light emitting display panel. The scan driving control signal SCS generated in the timing controller 150 is supplied to the scan driver 110, and the data driving control signal DCS is supplied to the data driver 120. The timing controller 150 supplies the data Data supplied from the outside to the data driver 120.

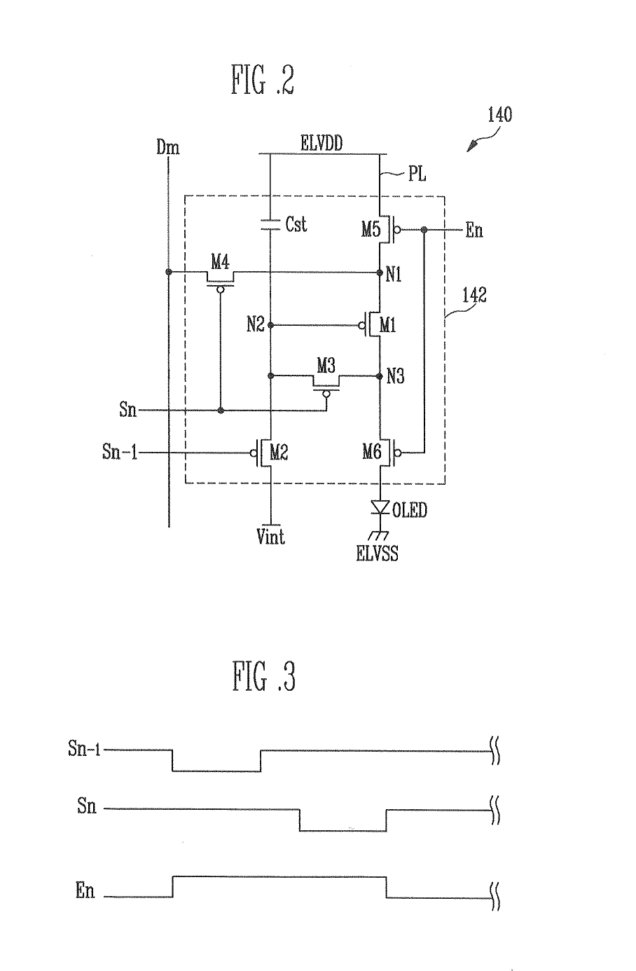

FIG. 2 is a circuit diagram illustrating an embodiment of the pixel shown in FIG. 1. For convenience, a pixel positioned on an n-th horizontal line and an m-th vertical line is shown in FIG. 2. Meanwhile, the embodiment disclosed in FIG. 2 is merely one embodiment for illustrating the structure of the pixel, and the pixel applicable to the present invention is not limited to the embodiment shown in FIG. 2. It will be apparent that the structure of the pixel may be variously modified and embodied.

In reference to FIG. 2, the pixel 140 according to this embodiment includes an organic light emitting diode OLED, and a pixel circuit 142 coupled to scan lines Sn−1 and Sn, an emission control line En, a data line Dm and a first power line PL so as to drive the organic light emitting diode OLED.

The organic light emitting diode OLED is coupled between the pixel circuit 142 and the second power source ELVSS. Here, the voltage of the second power source ELVSS is set lower than that of the first power source ELVDD. As such, the organic light emitting diode OLED generates light with a luminance corresponding to driving current supplied from the pixel circuit 142.

The pixel circuit 142 controls the amount of driving current supplied to the organic light emitting diode OLED, corresponding to a data signal supplied to the data line Dm when a scan signal is supplied to the scan line Sn. To this end, the pixel circuit 142 includes first to sixth transistors M1 to M6 and a storage capacitor Cst.

A first electrode of the first transistor M1 is coupled to a first node N1, and a second electrode of the first transistor M1 is coupled to a third node N3. A gate electrode of the first transistor M1 is coupled to a second node N2. The first transistor M1 supplies, to the organic light emitting diode OLED, driving current corresponding to the voltage at the second node N2.

The second transistor M2 is coupled between the second node N2 and an initialization power source Vint. A gate electrode of the second transistor M2 is coupled to the previous scan line, i.e., the (n−1)-th scan line Sn−1. The second transistor M2 is turned on when the scan signal is supplied to the (n−1)-th scan line Sn−1, so as to supply the voltage of the initialization power source Vint to the second node N2. Here, the voltage of the initialization power source Vint is set lower than that of the data signal. Meanwhile, although it has been described in this embodiment that the second transistor M2 is controlled by a previous scan signal, the second transistor M2 may be designed to be controlled by a separate control signal in addition to the previous scan signal.

A first electrode of the third transistor M3 is coupled to the second electrode of the first transistor M1, and a second electrode of the third transistor M3 is coupled to the second node N2. A gate electrode of the third transistor M3 is coupled to the n-th scan line Sn. The third transistor M3 is turned on when the scan signal is supplied to the n-th scan line, so as to allow the first transistor M1 to be diode-coupled.

A first electrode of the fourth transistor M4 is coupled to the data line Dm, and a second electrode of the fourth transistor M4 is coupled to the first node N1. A gate electrode of the fourth transistor M4 is coupled to the n-th scan line Sn. The fourth transistor M4 is turned on when the scan signal is supplied to the n-th scan line Sn, so as to supply, to the first node N1, the data signal supplied to the data line Dm.

A first electrode of the fifth transistor M5 is coupled to the first power source ELVDD, and a second electrode of the fifth transistor M5 is coupled to the first node N1. A gate electrode of the fifth transistor M5 is coupled to the emission control line En. The fifth transistor M5 is turned off when an emission control signal is supplied from the emission control line En, so as to block driving current from being supplied to the organic light emitting diode OLED. The fifth transistor M5 is turned on when the emission control signal is not supplied from the emission control line En, so as to allow the first power source ELVDD and the first node N1 to be electrically coupled to each other.

A first electrode of the sixth transistor M6 is coupled to the third node N3, and a second electrode of the sixth transistor M6 is coupled to an anode electrode of the organic light emitting diode OLED. A gate electrode of the sixth transistor M6 is coupled to the emission control line En. The sixth transistor M6 is turned off when the emission control signal is supplied from the emission control line En, so as to block driving current from being supplied to the organic light emitting diode OLED. The sixth transistor M6 is turned on when the emission control signal is not supplied from the emission control line En, so as to supply driving current supplied from the first transistor M1 to the organic light emitting diode OLED.

The storage capacitor Cst is coupled between the first power source ELVDD and the second node N2. The storage capacitor Cst charges a voltage corresponding to that of the data signal supplied to the second node N2.

FIG. 3 is a waveform diagram illustrating driving signals supplied to the pixel shown in FIG. 2.

Hereinafter, a driving method of the pixel shown in FIG. 2 will be described with reference to FIG. 3 in conjunction with FIG. 2.

First, if a low-voltage scan signal is supplied to the (n−1)-th scan line Sn−1, the second transistor M2 is turned on. If the second transistor M2 is turned on, the voltage of the initialization power source Vint is supplied to the second node N2.

The voltage of the initialization power source Vint is set lower than that of the data signal. Accordingly, the voltage at the second node N2 is initialized as a voltage lower than that of the data signal.

Subsequently, the low-voltage scan signal is supplied to the n-th scan line Sn. If the scan signal is supplied to the n-th scan line Sn, the third and fourth transistors M3 and M4 are turned on. If the fourth transistor M4 is turned on, the data signal supplied to the data line Dm is supplied to the first node N1. If the third transistor M3 is turned on, the first transistor M1 is diode-coupled.

In this case, the voltage at the second node N2 is initialized as the voltage of the initialization power source Vint, and hence the first transistor M1 is turned on. Then, the data signal supplied to the first node N1 is supplied to the second node N2 via the diode-coupled first transistor M1. Accordingly, the voltage at the second node N2 is increased to a voltage obtained by subtracting the threshold voltage of the first transistor M1 from the voltage of the data signal. In this case, the voltage applied to the second node N2 is stored in the storage capacitor Cst.

If the supply of a high-voltage emission control signal supplied to the emission control line En after a predetermined voltage is charged in the storage capacitor Cst, the fifth and sixth transistors M5 and M6 are turned on. If the fifth and sixth transistors M5 and M6 are turned on, there is formed a current path of driving current flowing from the first power source ELVDD to the second power source ELVSS via the fifth, first and sixth transistors M5, M1 and M6 and the organic light emitting diode OLED. In this case, the first transistor M1 controls the amount of the driving current flowing the organic light emitting diode OLED from the first power source ELVDD, corresponding to the voltage charged in the storage capacitor Cst. Accordingly, the organic light emitting diode OLED emits light with a luminance corresponding to the data signal.

As described above, the pixel 140 of the organic light emitting display device includes the fourth transistor M4 and the storage capacitor Cst, which are configured to write and store a data signal, and the first transistor M1 configured to control the amount of driving current, corresponding to the data signal. The pixel 140 may further include a relatively large number of electronic devices including the third transistor M3 configured to store the threshold voltage of the first transistor M1, the second transistor M2 configured to initialize the second node, the fifth and sixth transistors M5 and M6 configured to control the emission period, etc. If the number of electronic devices disposed in the pixel is increased, a plurality of power lines and signal lines coupled to the electronic devices are also arranged in the pixel. Accordingly, the interval between the lines and/or the electronic devices is narrowed, and therefore, a defect such as a short circuit may occur due to even a small impurity, which becomes serious as the resolution of the organic light emitting display device is increased.

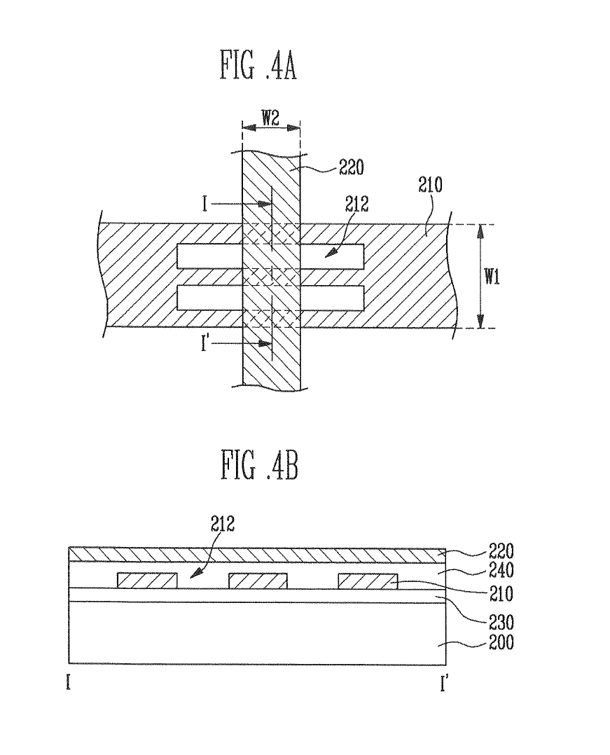

Thus, in the present invention, the shape of a line in a region where a defect relatively easily occurs, such as an intersection portion between lines, an intersection portion between a line and an electrode or an intersection portion between electrodes is modified and designed, so that it is possible to provide a pixel and an organic light emitting display device having the same which can be repaired. This will be described in detail below with reference to FIGS. 4A through 6.

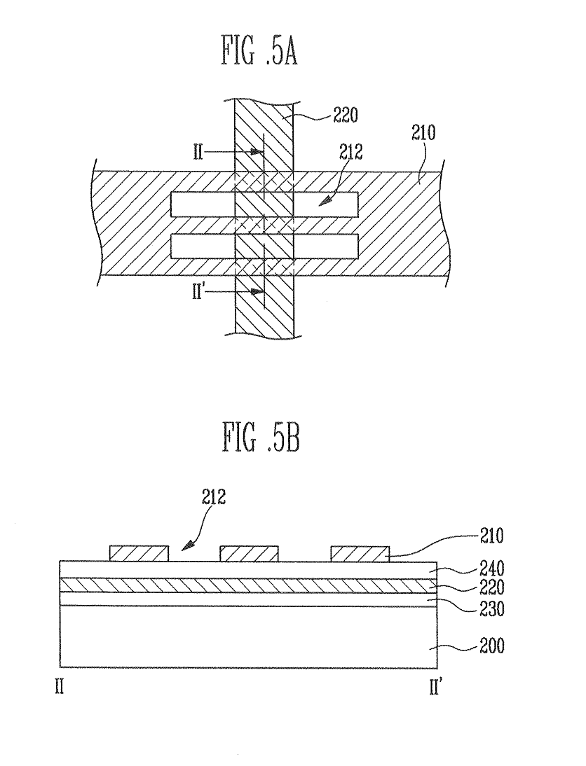

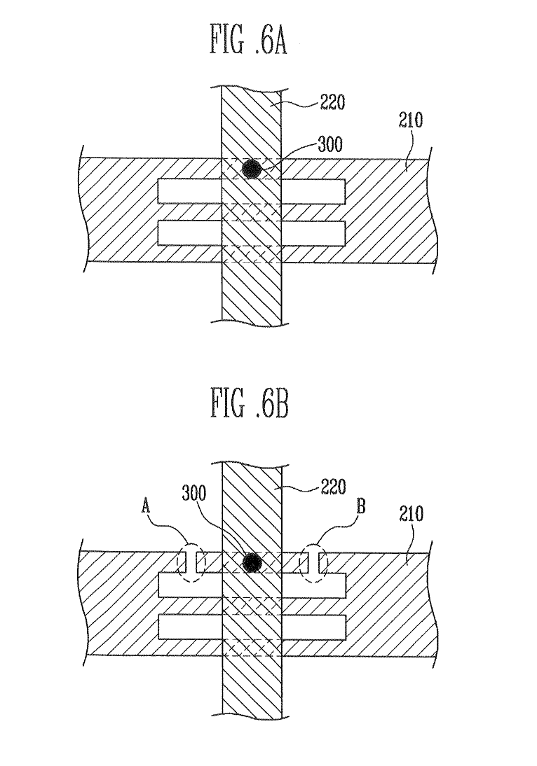

FIG. 4A shows two lines intersecting each other in a pixel, and particularly, is a main part plan view illustrating an example of a first line divided so that at least one region of the first line has a plurality of paths according to the embodiment of the present invention. FIG. 4B is a sectional view taken along line I-I′ of FIG. 4A. FIG. 5A is a main part plan view illustrating another embodiment in which the positions of the two lines shown in FIG. 4 are changed. FIG. 5B is a sectional view taken along line II-II′ of FIG. 5A. FIGS. 6A and 6B are main part plan views illustrating a repairing method of the pixel and a repairing structure of the pixel according to the embodiment of the present invention.

In order to more clearly describe technical features of the present invention, only two lines intersecting each other will be shown in FIGS. 4A through 6. The two lines may be arranged to intersect each other inside the pixel unit of the organic light emitting display device, particularly, in the pixels. The present invention is not necessarily to only an intersection portion between lines, and may be applied to an intersection portion between a line and an electrode or an intersection portion between electrodes.

First, in reference to FIG. 4A, at least two lines intersecting each other exist in the pixel of the organic light emitting display device. For example, first and second lines 210 and 220 may intersect each other while respectively disposed in first and second directions.

The first line 210 configured to supply the first power source ELVDD is disposed along the first direction, and the second line 220 configured to supply a data signal is disposed along the second direction, so that the first and second lines 210 and 220 can intersect each other.

The first and second lines 210 and 220 are disposed in different layers. As shown in FIG. 4B, the first and second lines 210 and 220 may intersect each other while overlapping with an insulation layer 240 interposed therebetween. The insulation layer 240 may be an electrical insulation layer.

For example, the first line 210 may be disposed in a gate layer, using the same material as that of a gate electrode of a transistor device (not shown) on a substrate 200 and a buffer layer 230. The second line 220 may be disposed in a layer upper than that in which the first line 210 is disposed while being disposed in a source/drain layer, using the same material as that of a source/drain electrode of the transistor device.

However, this is merely one embodiment for illustrating the present invention, and the present invention is not limited thereto. That is, the materials and positions of the first and second lines 210 and 220 may be variously modified and embodied. For example, as shown in FIGS. 5A and 5B, the first line 210 may be disposed in an upper layer of the second line 220.

In the present invention, at least one of the two lines intersecting each other, e.g., the first line 210 may be divided to have a plurality of paths in the overlapping region of the first line 210 with the second line 220. To this end, one or more openings 212 may be formed in the first line 210 at the intersection portion of the first and second lines 210 and 220.

For example, the first line 210 may be formed to have two openings 212 in the overlapping region of the first line 210 with the second line 220. In this case, the first line 210 may be divided to have three paths in the overlapping region.

The other region of the first line 210 may be formed to have a single path. To this end, the first line 210 may be formed so that the divided paths are put together to again have one path at the front end and rear end of the intersection portion divided into the plurality of paths.

If at least one of the first and second lines 210 and 220 intersecting each other is formed to a plurality of paths at the intersection portion of the first and second lines 210 and 220, the pixel can be normally operated by easily repairing the pixel even when a defect such as a short circuit occurs at the intersection portion.

More specifically, although a short circuit in which the first and second lines 210 and 220 are electrically coupled to each other occurs at the intersection portion of the first and second lines 210 and 220 due to a foreign matter 300 penetrated into one of the plurality of paths as shown in FIG. 6A, the pixel can be easily repaired by isolating the path in which the defect occurs from the other paths as shown in FIG. 6B.

To this end, as shown in FIG. 6B, surroundings of the region in which the short circuit occurs, e.g., regions A and B are decoupled using laser or the like, so that the path in which the defect occurs can be isolated from the other paths. That is, the isolated path is electrically coupled to the second line 220, but is isolated and disconnected from the other paths, so that the first and second lines 210 and 220 can be normally operated.

As described above, according to the present invention, at least one of two lines intersecting each other is formed to have a plurality of paths at the intersection portion of the lines, so that the pixel can be easily repaired through a simple repair process of cutting a portion at which a defect such as a short circuit occurs.

Meanwhile, for convenience, it has been described in the present invention that the two lines, i.e., the first and second lines 210 and 220 intersect each other. However, the present invention may be applied to a stacked structure between a line and an electrode or between two electrodes such as a gate electrode and a source/drain electrode, which are disposed in different layers with an insulation layer interposed therebetween.

For example, when the first line 210 intersect while overlapping with a source/drain electrode or a source/drain layer formed by extending the source/drain electrode, the first line 210 may be divided to have a plurality of paths at the intersection portion of the first line 210 with the electrode.

Although it has been illustrated in FIGS. 4A to 6 that one region of the first line 210 is divided to have a plurality of paths while the openings 212 are formed in the first line 210, the present invention is not limited thereto. For example, one region of the second line 220 may be divided to have a plurality of paths, or both the lines may be divided to have a plurality of paths at the intersection portion of the lines.

In a case where at least one of the two lines intersecting each other is divided to have a plurality of paths at the intersection portion of the lines, one region of one line having a width wider than that of the other line may be divided in order to secure stability from a defect such as a short circuit.

For example, in a case where the width W1 of the first line 210 is wider than that W2 of the second line 220 in a region where the first and second lines 210 and 220 overlap with each other as shown in FIGS. 4A and 5A, the method of designing the first line to be divided can be primarily considered.

In a case where the first line 210 is set as a first power line PL having a relatively wide width, and the second line 220 is set as a data line D or source/drain layer having a relatively narrow width, one or more openings 212 may be formed in the first line 210.

However, it will be apparent that this may be modified and embodied in consideration of layers in which the lines are positioned or other conditions. The present invention is not necessarily applied to all the intersection portions between lines, between a line and an electrode and between electrodes. This may be properly selected and applied in consideration of design conditions, failure possibility, importance, etc.

Meanwhile, in a case where a short circuit occurs at the intersection portion of the first and second lines 210 and 220 as shown in FIGS. 6A and 6B, the path in which the short circuit occurs is isolated from the other paths of the first line 210 in order to repair the pixel. However, it is unnecessary to perform such a repair process in a normal pixel in which a defect does not occur.

Thus, among a plurality of pixels designed by applying the present invention, only a pixel in which a short circuit occurs at an intersection portion can have the repaired structure as shown in FIG. 6B. The other pixels can maintain a state in which the pixels are to be repaired as shown in FIG. 6A.

As described above, according to the present invention, one region of a line intersecting while overlapping with another line or electrode among a plurality of lines arranged in the pixel unit, particularly, one region including an intersection portion at which the line intersects another line or electrode, is divided to have a plurality of paths.

Accordingly, in a case where a defect such as a short circuit occurs at the intersection portion, one path in which the short circuit occurs is isolated from the other paths, so that it is possible to easily repair the pixel, thereby improving the yield of the organic light emitting display device.

By way of summation and review, the organic light emitting display device is classified into a passive matrix type organic light emitting display (PMOLED) device and an active matrix type organic light emitting display (AMOLED) device according to the method of driving an organic light emitting diode.

The AMOLED device has low power consumption, and thus the application field of the AMOLED device has been extended.

The AMOLED device includes a plurality of pixels arranged at intersection portions of scan lines and data lines. Each pixel includes an organic light emitting diode, and a pixel circuit configured to supply, to the organic light emitting diode, driving current corresponding to a data signal.

Generally, the pixel circuit includes a driving transistor configured to control driving current supplied to the organic light emitting diode, a switching transistor configured to transmit a data signal to the driving transistor, and a storage capacitor configured to maintain the voltage of the data signal. The pixel circuit may further include a larger number of electronic devices including a transistor configured to compensate for the threshold voltage of the driving transistor and a transistor configured to transmit an initialization voltage to the pixel circuit.

Accordingly, a plurality of transistors and capacitors, and power lines and signal lines coupled thereto are arranged in the pixel of the AMOLED device.

However, if a plurality of electronic devices and lines are arranged in the pixel as described above, the intervals between the electronic devices and the lines is narrowed, and therefore, a defect may occur in the pixel. Particularly, the interval may be further narrowed as the resolution of the AMOLED device is increased. Therefore, a defect such as a short circuit may easily occur due to a small impurity. Accordingly, it is highly likely that a defect may occur in the pixel circuit, thereby lowering the yield of the AMOLED device.

In the pixel and the organic light emitting display device according to embodiments of the present invention, one region of a line intersecting while overlapping with another line or electrode among a plurality of lines arranged in the pixel unit, particularly, one region including an intersection portion at which the line intersects another line or electrode, is divided to have a plurality of paths.

Accordingly, in a case where a defect such as a short circuit occurs at the intersection portion, one path in which the short circuit occurs is isolated from the other paths, so that it is possible to easily repair the pixel, thereby improving the yield of the organic light emitting display device.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A pixel, comprising:
a plurality of lines configured to include a scan line, a data line and a first power line, the plurality of lines arranged in a first or second direction;
a pixel circuit coupled to the lines; and
an organic light emitting diode coupled between the pixel circuit and a second power source,
wherein a first line disposed in the first direction among the plurality of lines intersects while overlapping with a second line disposed in the second direction among the plurality of lines or with one or more electrodes on another layer, and
wherein the first line is divided to have a plurality of paths in at least one region in the overlapping region of the first line with the second line or the one or more electrodes.

2. The pixel of claim 1, wherein the first line is formed so that the divided paths are put together at a front end and a rear end of the region divided to have the plurality of paths.

3. The pixel of claim 1, wherein the first and second lines or the first line and the one or more electrodes intersect each other with an insulation layer interposed therebetween.

4. The pixel of claim 1, wherein a width of the first line in the overlapping region is formed wider than that of the second line.

5. The pixel of claim 1, wherein the first line is set as the first power line.

6. The pixel of claim 1, wherein one or more paths among the divided paths of the first line are electrically coupled to the second line or the one or more electrodes at the intersection portion of the first and second lines or the intersection portion of the first line and the one or more electrodes, and
wherein the path electrically coupled to the second line or the one or more electrodes is isolated from the other paths of the first line.

7. An organic light emitting display device, comprising:
a plurality of lines configured to include scan lines, data lines and first power lines, arranged in a first or second direction; and
a plurality of pixels arranged at intersection portions of the scan lines, the data lines and the first power lines,
wherein each pixel includes:
a pixel circuit coupled a scan line, a data line and a first power line on a corresponding row or column among the plurality of lines; and
an organic light emitting diode coupled between the pixel circuit and a second power source,
wherein a first line disposed in the first direction among the plurality of lines intersects while overlapping with a second line disposed in the second direction among the plurality of lines or with one or more electrodes on another layer, and
wherein the first line is divided to have a plurality of paths in at least one region in the overlapping region of the first line with the second line or the one or more electrodes.

8. The organic light emitting display device of claim 7, wherein the first line is formed to have one or more openings in the overlapping region of the first line with the second line or the one or more electrodes.

9. The organic light emitting display device of claim 7, wherein the first and second lines or the first line and one or more electrodes intersect each other with an insulation layer interposed therebetween.

10. The organic light emitting display device of claim 7, wherein a width of the first line in the overlapping region is formed wider than that of the second line.

11. The organic light emitting display device of claim 7, wherein one or more paths among the divided paths of the first lines, provided in one or more pixels among the plurality of pixels, are electrically coupled to the second line or the one or more electrodes at the overlapping region of the path with the second line or the one or more electrodes, and
wherein the path electrically coupled to the second line or the one or more electrodes is isolated from the other paths of the first line.
